(19) United States
(12) Patent Application Publication
(10) Pub. No.: US 2021/0302545 A1
(43) Pub. Date: Sep. 30, 2021

(54) ADAPTIVE METHOD AND MECHANISMS FOR FAST LIDAR AND POSITIONING APPLICATIONS

(71) Applicant: ORTA DOGU TEKNIK UNIVERSITESI, Ankara (TR)

(72) Inventors: Emre YUCE, Ankara (TR); Cagdas Anil YUKSEL, Ankara (TR)

(73) Assignee: ORTA DOGU TEKNIK UNIVERSITESI, Ankara (TR)

(21) Appl. No.: 17/269,545

(22) PCT Filed: Dec. 6, 2019
(86) PCT No.: PCT/TR2019/051040

§ 371 Date: Feb. 19, 2021

(30) Foreign Application Priority Data
Dec. 19, 2018 (TR) 2018/19800

(51) Int. Cl. G01S 7/481; G02B 26/12; G02B 26/10; G01S 17/89

(52) U.S. Cl. CPC G01S 7/4817; G01S 17/89; G02B 26/108; G02B 26/12

(57) ABSTRACT

A system to develop a light detection and range determination (LIDAR) application by a rotation of optical elements embedded on a rotating disk in a spherical geometry is provided. The system further enables to conduct a fastest possible spatial scanning mechanically and to determine flight times of light beams by adaptive elements according to a distance and a size of a target region.

### CROSS REFERENCE TO THE RELATED APPLICATIONS

This application is the national stage entry of International Application No. PCT/TR2019/051040, filed on Dec. 6, 2019, which is based upon and claims priority to Turkish Patent Application No. 2018/19800, filed on Dec. 19, 2018, the entire contents of which are incorporated herein by reference.

### TECHNICAL FIELD

The invention is related to a system which enables to develop a LIDAR application by means of the rotation of optical elements that have been embedded on a rotating disk in a spherical array, which also enables to conduct the fastest possible spatial scanning mechanically and determine the time of flight of light beams.

### BACKGROUND

The term LIDAR has been derived from the term RADAR, and it is a laser aided, 3-dimensional high resolution ranging and depth measurement system. The light beams are sent from the source to the object that is within the range of vision in LIDARs, and the time of flight of the beams that are reflected from the object are measured by sensors and the distance and shape of the targeted object are calculated. LIDARs are crucially important for today's technology where automation is gaining importance and different LIDAR versions are already being used. The applications of LIDARs can be listed as autonomous land and air devices, robotics, navigation, scanning and alarm systems, security, geodesy and photogrammetry. Nowadays several different LIDAR types are available. These can be listed as flash LIDARs, solid-state LIDARs, optical phased array LIDAR's and MEMS-based LIDARs etc. The operation principle of all of these LIDARs includes the calculation of flight time, by means of a time sensing electronic circuit.

LIDARs can be grouped under two main systems. These systems are called mechanical and electromagnetic beam directing systems. As it has already been mentioned above, the sensors are stimulated by the source beam and the time of flight is then calculated. The beam can be directed to the target if the source beam is controlled directly or by means of movable mirrors These systems can be given as examples of mechanical systems.

In mechanically directing systems, a mechanical rotator is used to direct the laser beam or movable mirrors are used to direct light. However, these systems perform spatial scanning at a very low speed. These systems use two different mirrors that have been placed on two motors (step or servo motor) in order to scan every point of space. These motors travel to the predetermined locations one by one and carry out scanning. Due to this reason the scanning speed is low. Additionally, systems that use a single mirror which continuously rotates is also present. In this case, the system performs scanning only at a single axis. A different laser is used in order to perform scanning on a second axis and this increases the cost of the system. Solid state systems steer light beams by one or more micro mirrors that scan a certain solid angle. However these systems are not preferred as they cannot reach the required resolution values and scanning speed, and they are expensive as they are high technology products.

Several projector systems that are hybrid system products consisting of solid state and mechanical systems for end users are being used in the market nowadays. These systems which are durable and have low power consumption, fall behind other systems when the number of points scanned in a second by LIDARs is taken into consideration. The production of these systems is very difficult and expensive. Optical phased arrays operate on the principle of directing light as a result of constructive interference of electromagnetic waves at the desired direction and distance, which is similar to phased array antennas. These systems are high technology systems, however, they are more cost-effective in comparison to solid state systems. Although the most important disadvantage is that they cannot reach the adequate effective distance, an optical phased array system that has been made into a product is not available.

Systems that reach high resolution and high scanning rates are generally formed of expensive mechanisms. In systems where this problem is solved by optical phased arrays, the scanning distance arises as to the problem depending on the reduction of optical power. However such systems are expensive as they utilize advanced technology and are complex. Some of the fast versions of LIDAR technologies in the market are MEMS-based. Clean rooms and equipment that are expensive are required in order to produce these products. It is possible to scan 20.000 points per second with MEMS-based mirrors.

### SUMMARY

The present invention is related to adaptive methods and mechanisms for fast LIDAR (light detection and range determination) and positioning applications in order to eliminate the disadvantages mentioned above and to bring about new advantages to the related technical field.

The invention is related to beam directing and distance detection apparatus and method which enables to produce the high resolution and high-speed scanning LIDAR which is a requirement nowadays, cost-effectively and rapidly. Our system which solves the high resolution, high scanning speed, and highly effective distance problems with one component is a system that can be easily produced.

The invention we have set forth, provides novel solutions for design, sensing of light, distance measurement, and remote active sensing applications. This invention which we have set forth enables to develop a LIDAR application by means of the rotation of optical elements that have been placed on a rotating disk in a spherical array, which also enables to conduct the fastest possible spatial scanning mechanically and to determine the flight times of these light beams. By means of the design we have developed, our design presents a method to produce a system with CNC or 3-dimensional printers without necessitating the usage of expensive equipment or clean rooms for production. Due to this reason, our design provides rapid and easy production advantages.

According to a preferred embodiment of the invention, the elements on the disk of the mechanical light beam director are formed of mirrors.

According to another preferred embodiment of the invention, the mirrors are selected from micromirrors, concave, convex and dual optical mirrors.

According to another preferred embodiment of the invention, the elements on the disk of the mechanical light beam director are formed of prisms.

According to another preferred embodiment of the invention, the prisms are selected from micro prisms, concave, convex and dual optical prism structures.

According to another preferred embodiment of the invention, the elements on the disk of the mechanical light beam director are phase masks.

According to another preferred embodiment of the invention said phase mask has a continuous or noncontinuous structure.

According to another preferred embodiment of the invention, the elements on the disk of the mechanical light beam director are light sources.

According to another preferred embodiment of the invention, a mechanical light beam director comprises at least a disk formed of at least one element.

According to another preferred embodiment of the invention, the elements of the mechanical light beam director form at least one serial structure on the disk.

According to another preferred embodiment of the invention, the mechanical light beam director disk has a monotype element thereon.

According to another preferred embodiment of the invention, the optical sensor element (130) is an avalanche photodiode.

According to another preferred embodiment of the invention, the optical sensor element (130) comprises positive semi-conductive, negative diodes.

According to another preferred embodiment of the invention, the optical sensor element (130) is formed of at least a detector.

According to another preferred embodiment of the invention, the optical sensor element (130) is connected to the reading circuits electrically or optically. Preferably a lens or optical element similar to lenses is provided at the front section of the sensor element.

According to another preferred embodiment of the invention, the optical sensor element (130) is formed as a focal plane array of photodiodes that are formed of a plurality of detectors.

According to another preferred embodiment of the invention, the light source (131) is at least one laser, a led, fluorescence, light source based on electricity discharge or a glow lamp.

According to another preferred embodiment of the invention, the laser is a single and/or multiple pulsating lasers.

According to another preferred embodiment of the invention, the light source (131) is an optical diffuser which is a cube beam splitter, prism beam splitter, pellicle beam splitter, or a partially metalized mirror which is used to simultaneously split the laser beam and transmit it to the elements on the disk of the LIDAR system, and at the same which transmits the other split laser beam to the optical sensors of the LIDAR system, which also divides the visible or infrared light intensity into sections.

According to another preferred embodiment of the invention, the optical diffuser is made of an amorphous silicon crystal, silicon-nitrite or material having a crystal structure.

According to another preferred embodiment of the invention, the light sources are hybrid or monolithically integrated with optical boosters, optical sensors, detector electronics, and power regulating electronics, control electronics, data convertor electronic and processors together with one or more light sources, drivers and controller circuits.

According to another preferred embodiment of the invention, the integration of light sources includes integration with a plurality of modules.

According to another preferred embodiment of the invention the LIDAR ranging apparatus can be connected to global positioning system sensors, global positioning system satellite sensors, inertial measurement units, wheel encoders, visible video cameras, infrared video cameras, radars, ultrasonic sensors, embedded processors, ethernet controllers, cellular modems, wireless controllers, data recording devices, human-machine interfaces, power supplies, coating, cabling and retainer devices, such that they are connected with at least one or a plurality of modules.

The mentioned LIDAR system can be directly or indirectly connected to the below-mentioned modules.

The modules can be one or a plurality of global positioning system sensors, global positioning system satellite sensors, inertial measurement units, wheel encoders, visible video cameras, infrared video cameras, radars, ultrasonic sensors, embedded processors, ethernet controllers, cellular modems, wireless controllers, data recording devices, human-machine interfaces, power supplies, coating, cabling and retainer devices.

According to another embodiment of the invention, in the LIDAR ranging apparatus, the LIDAR and the video camera are integrated onto the same printed circuit.

According to another preferred embodiment of the invention, the fourth unit (140) is an electric motor or a mechanical motor.

According to another embodiment of the invention, the optical sensor element (130) is one or a plurality of phototransistors, a thermal sensor or a single-photon detector.

According to a preferred embodiment of the invention, the optical sensor comprises at least a photodetector.

According to another preferred embodiment of the invention, a plurality of detectors are avalanche photodiodes.

According to another preferred embodiment of the invention, the photodetector is connectable to the electrical or optical reading circuit.

According to another preferred embodiment of the invention, the optical sensor which comprises a plurality of photodetectors is formed as a focal plane array.

According to another preferred embodiment of the invention, the optical sensor is integrated on the same printed circuit as the LIDAR.

According to another preferred embodiment of the invention, additionally, a light source and a processor is integrated on the printed circuit.

According to another preferred embodiment of the invention, the mirror and other optical elements that are required for spatial scanning are for predetermined angles and in that they are placed on a rotating disk.

### BRIEF DESCRIPTION OF THE DRAWINGS

FIG. 1: shows the optical steering element arranged in rotationary disc direct the beam to the desired point on target scene.

FIG. 1A: Shows the different points of each array of elements of the rotating disk onto which the spherical array of elements have been embedded (micromirror for this example).

FIG. 2: Shows the design for transparent optical elements positioned on rotationary disc.

FIG. 3A: Shows the view of the plurality of beam directing elements that have been placed on the disc on a horizontal and vertical axis.

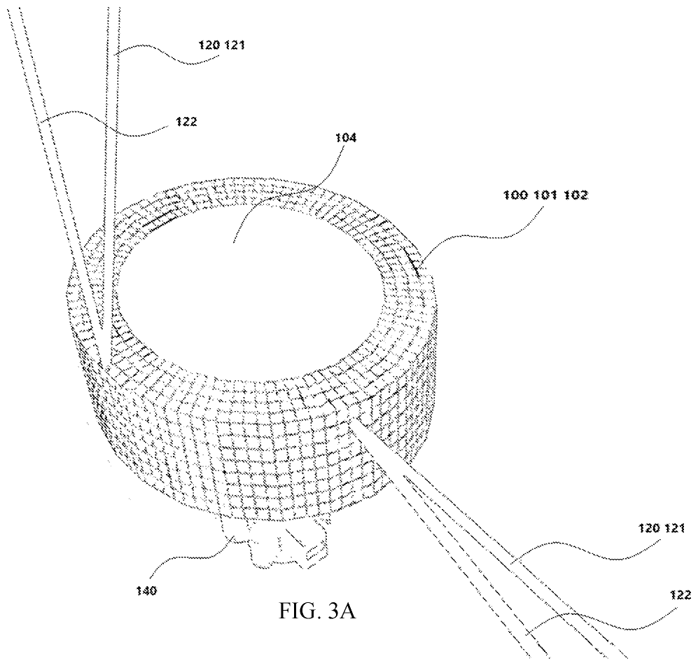

FIG. 3B: Shows the representative view of the system that is positioned on a rotating platform formed of a plurality of beam directing elements that have been placed on the disc on a horizontal and vertical axis.

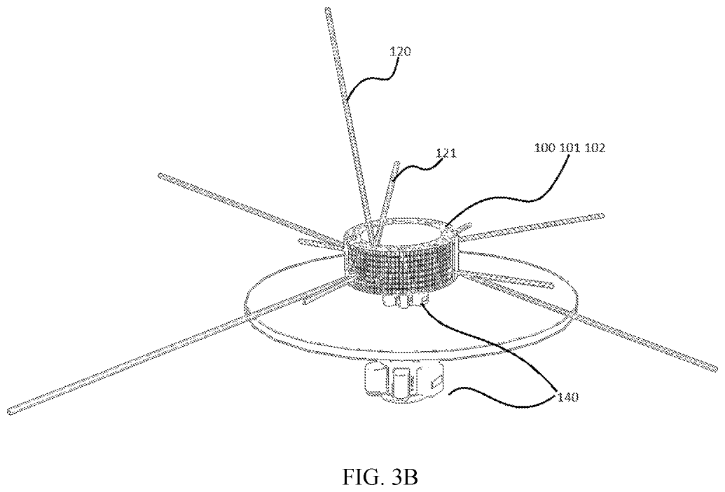

FIG. 4A: Is a different view of systems that are formed of a plurality of disks that have been designed according to requirements.

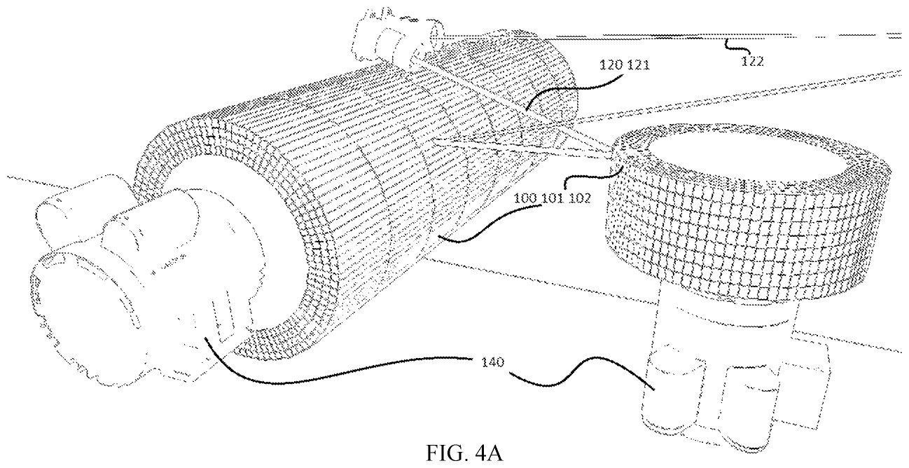

FIG. 4B: Is a different view of systems that are formed of a plurality of disks.

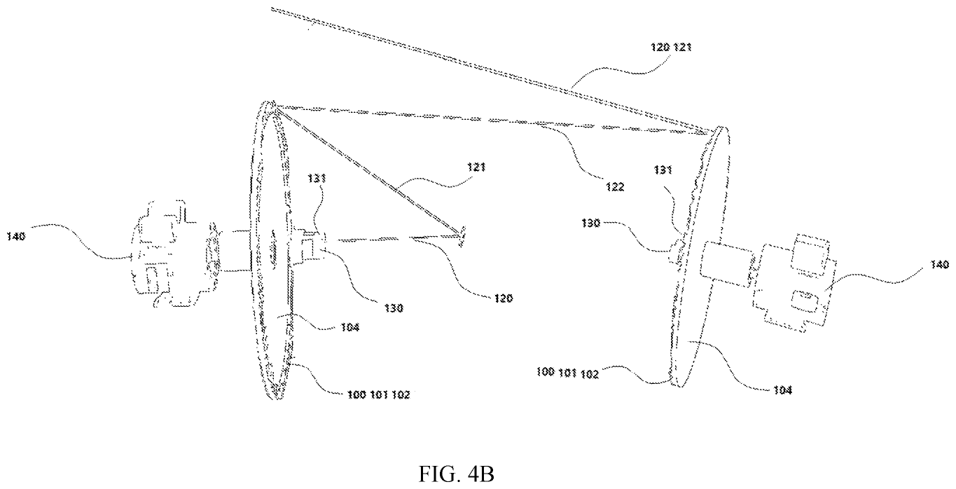

FIG. 4C: Is another different view of systems that are formed of a plurality of disks.

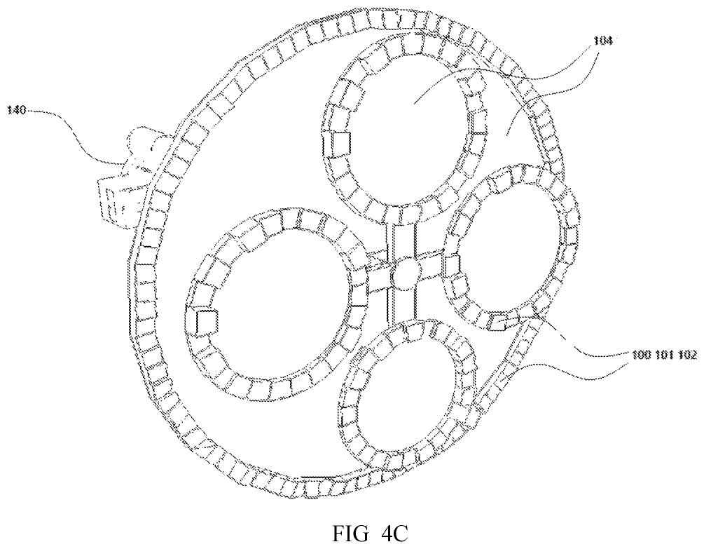

FIG. 4D: Is another different view of systems that are formed of a plurality of disks.

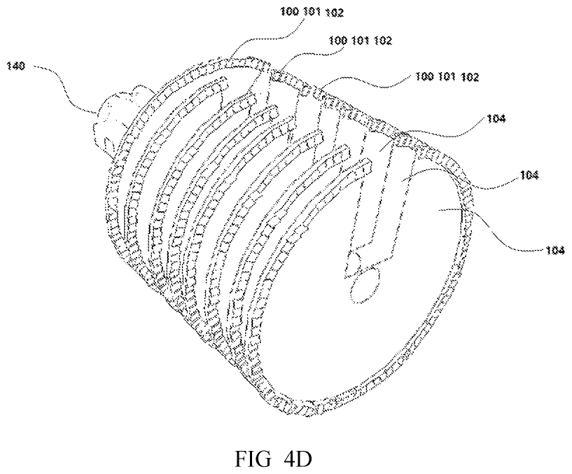

FIG. 5: The view of direction angles for mirror/micromirror beam directing elements.

FIG. 6: The view of the direction angles calculated for 3 different mirrors/micromirrors.

FIG. 7: The view of direction angles for prism/microprism beam directing elements.

FIG. 8: Is the view of the prism/microprism director that has been determined with two different angles.

FIG. 9: Shows the diffractive optical elements.

FIG. 10. The 2-dimensional view of the possible beam directing elements.

FIG. 11. Reflective or transmissive disc onto which surface function has been written.

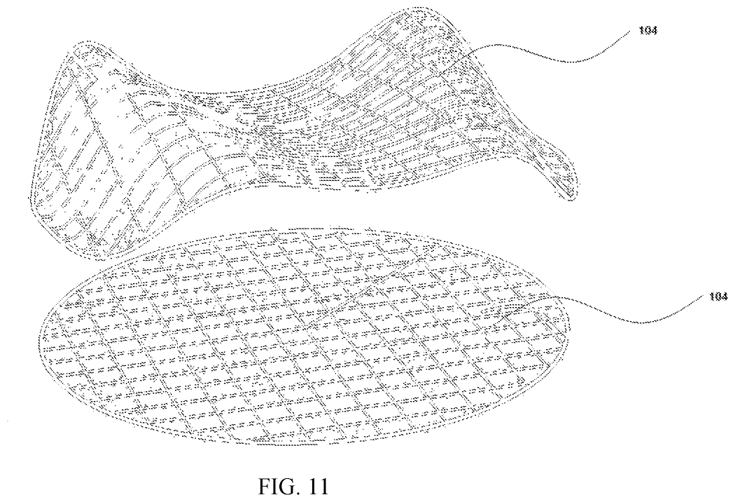

FIG. 12. Shows the general scheme for LIDAR diagram.

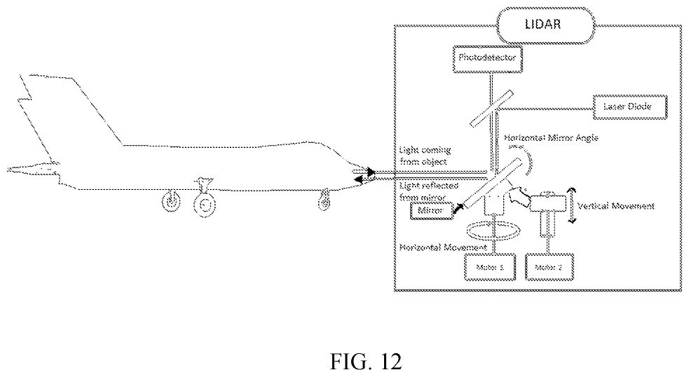

FIG. 13. Shows the block diagram of the novel LIDAR system.

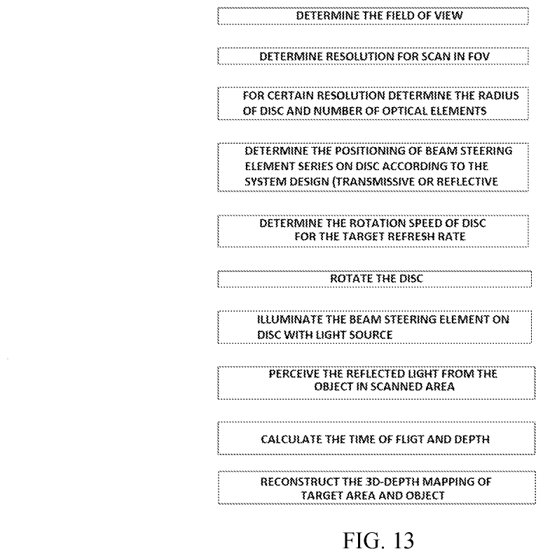

### REFERENCE NUMBERS

100 First Row (Ring) Spherical Array of Elements
101 Second Row (Ring) Elements
102 Third Row (Ring) Elements
104 Rotating Unit
111 The Outer Radius of the Disk
112 The Inner Radius of the Disk
120 Light Beam
121 Reflecting Light Beam
122 Light Beam Reflected from the Object
130 Sensor Element
131 Light Source
132 Reflecting Mirror
140 Rotator Unit

### DETAILED DESCRIPTION OF THE EMBODIMENTS

The novelty of the invention has been described with examples that shall not limit the scope of the invention and which have been intended to only clarify the subject matter of the invention. LIDARs are basically based on the principle of directing and scanning light in space and measuring flight distance. Our invention enables the light to be directed rapidly and with high resolution. The basic feature which distinguishes the present system from others is the method of directing principle light. Our invention consists of a disk and/or disks that are beam directing apparatus that is different to all of the systems developed to date.

As it is clearly shown in the figures the control over the direction of light can be rapidly carried out by using one or more disks. Reflective or permeable systems can be designed with one or more array of optical elements located on the same disk (these can be micromirrors, micro prisms, phase masks or their own light source). The best advantage that is provided by our invention is that the mirror and other optical elements that are required for spatial scanning are designed for predetermined angles and these elements are placed on a rotating disk. By this means 2-dimensional spatial scanning can be carried out with low cost and high speed. The third dimension information is carried out by calculating the time of flight of light. Our invention provides high resolution, high scanning speed and increases effective distance. It is easy to be produced and it has a design that can contribute to different imaging and analysis systems. For example, the area of a disk having a 15 cm radius is approximately 706 cm and 942 square-shaped mirrors (having 0.01 cm area) having a 1 mm section can be placed on this disk (more than 60 thousand can be placed in total if the whole area is used). Depending on rotation speed, approximately 1-kilohertz rotation speed means 942 thousand points only in one row. Again, during a 1-kilohertz rotation speed, when all points are used these correspond to 60 million points. As the disk rotates, the next array of elements located on the disk shall face another point in space. As the rotation speed increases, the number of scanned points in a second by the light source shall also increase. The speed of rotation is directly related to the renewal speed of the target scene. If we note that today, rotation speeds can reach up to megahertz values, we can perceive that the renewal speed of the target scene shall reach higher values in comparison to all of the other LIDAR examples.

The invention is related to performing 3 dimension depth as a result of directing light by the aid of optical elements that have been placed on a disk. Each one of the elements that have been placed on the rotating disk, have been positioned such that they can direct light to different sections in space and as the disk rotates the next element in the row, has been optimized to scan different regions. The system of the invention can be adjusted or scaled according to the desired criteria (resolution, angle of vision, scanning speed etc.). By means of our design, it is possible for us to reach this speed with much lower costs. Our design is basically formed of a motor mirror and a distance meter. The costs of these products are much lower in comparison to the high-speed LIDARs that are present in the market. Other LIDAR systems based on rotating mirrors, use a plurality of lasers for performing two-dimension scanning. As the need for resolution increases the number of lasers also increase and this makes production difficult and increases costs. It shall be possible for us to perform high-resolution spatial scanning with a single laser at much lower costs by controlling the position and angles of the mirror.

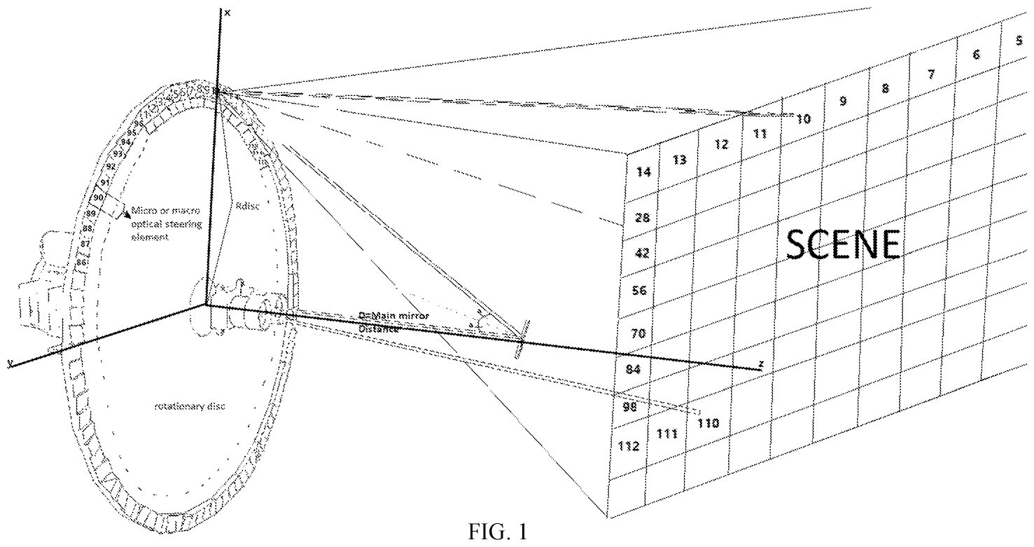

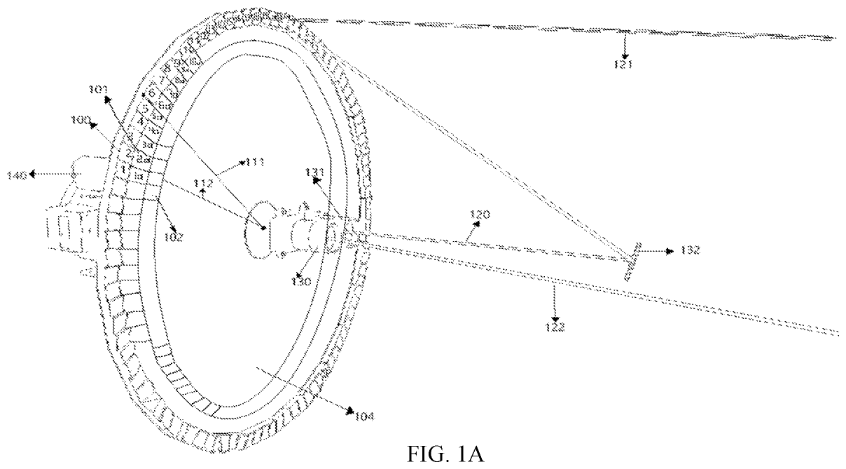

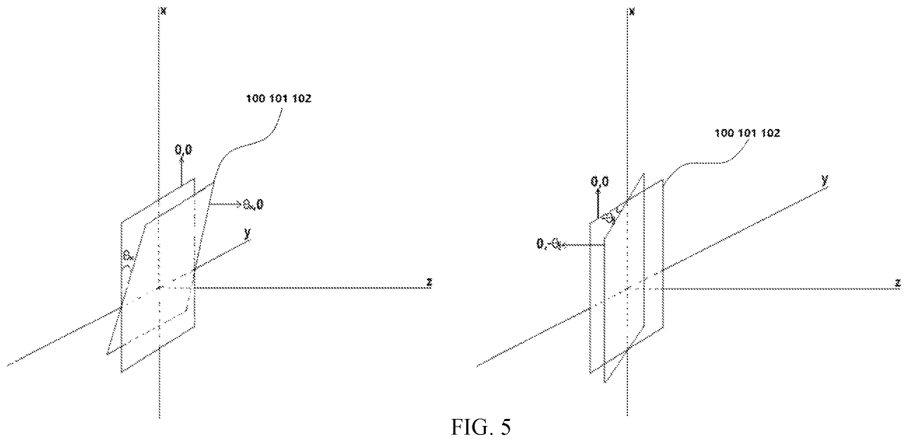

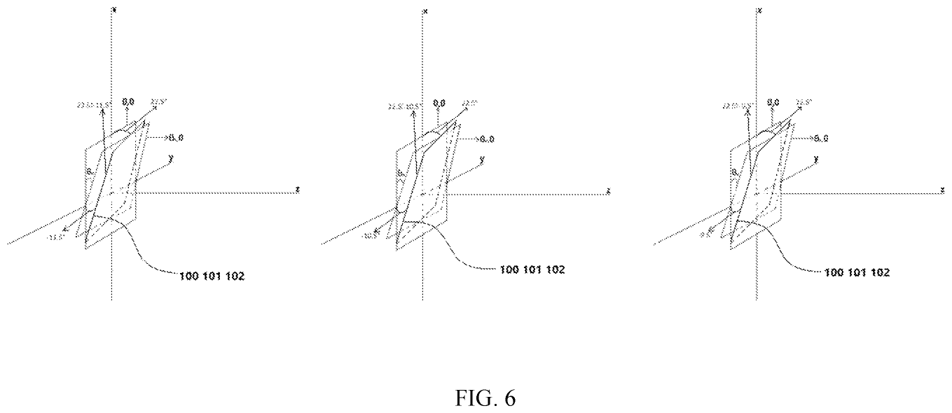

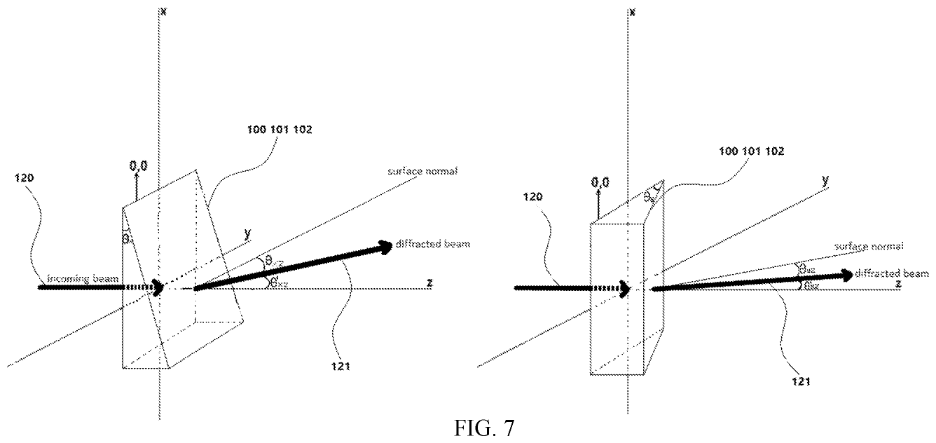

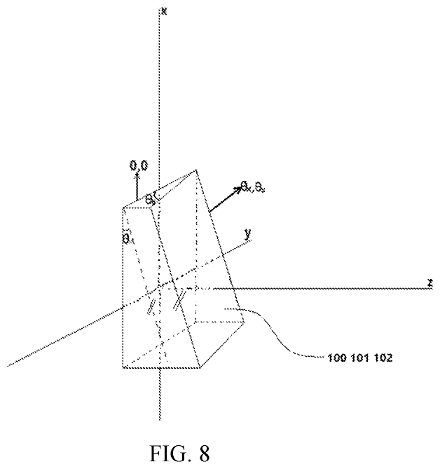

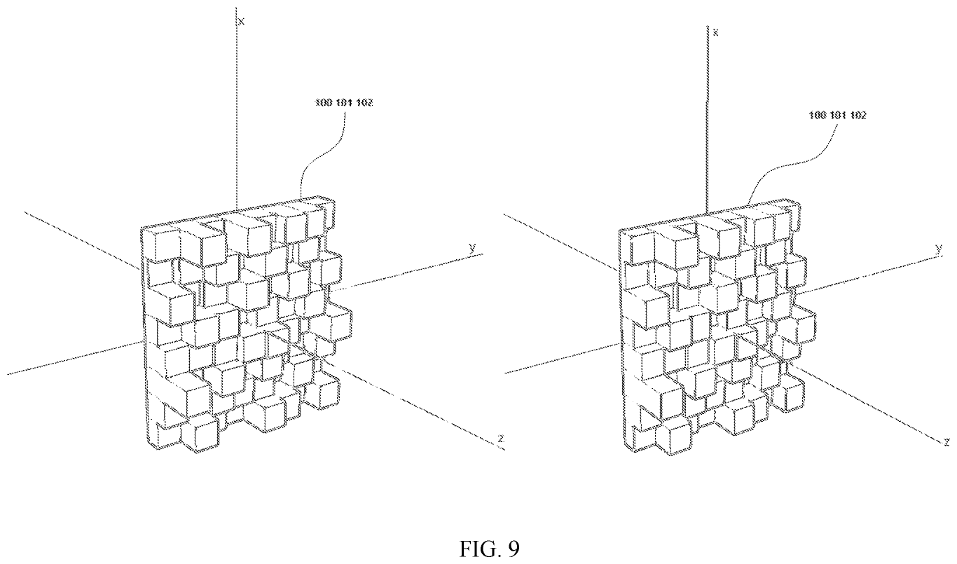

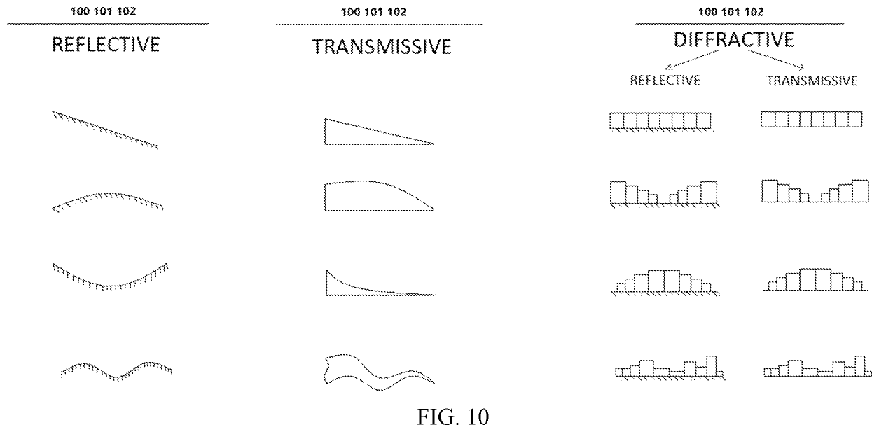

Referring to FIG. 1A, it can be seen that spherically positioned array elements have been provided on the disk. The spherically positioned array elements are first row (first ring) spherical array elements (100), second row (ring) elements (101) and third row (ring) elements (102). The first row of spherical array elements (100) on the disk can be (first ring) can be a mirror. The mirror can be micro, concave, convex and dual mirror. Spherical array elements can also be used permeably as prism form. Prisms can be of micro, concave, convex and dual type. A phase mask can be used for objects whose distance is approximately known. These optical elements can be of any kind illustrated in FIGS. 5-10. Additionally, the spherical array elements can be an independent light source such as a laser, led or fluorescent. The second row (ring) elements (101) and third row (ring) elements (102) can be the same as the first row of (first ring) spherical array elements (100). The outer radius (111) of the disk and the inner radius (112) of the disk has been shown in FIG. 1. The fourth unit (140) can be an electric motor or mechanical motor. The light source (131) can be a single or multiple pulsed laser, continuous laser, led or fluorescent. The optical sensor element (130) can be one or a plurality of photodiodes, a phototransistor, thermal sensor, a single photon detector etc. A rotating unit (104) has been provided which is rotated by means of a rotator. This rotating unit (104) can be made of any kind of material. At the same time, it can be of the same material as the spherical array elements. Its radius can change depending on rotating speed. A reflective mirror (132) specific to design has also been provided. This reflective mirror (132) can be convex or concave and it can be moved in at least an axis. This mirror may not be required to be used for similar designs (that have different laser and detector directions).

The light beam (120) that is emitted out of the light source (131), the light beam (121) that is reflected from the spherical array element (this can be permeable for another design) whose destination is predetermined and the light beam (122) that is emitted out of the object inside the field of vision is shown in FIG. 1A.

The light source (pulsed laser for this system) (131) illuminates the spherical array of elements or in other words the first row of (first ring) spherical array elements (100), second row (ring) elements (101) and third row (ring) elements (102), within a predetermined and/or undetermined period of time. The laser directs the light beam (121) received from the spherical array elements (100) from the first row of spherical array elements, second row (ring) spherical array elements (101) and third row (ring) elements (102) (a micromirror whose direction has been determined for this system), to the object in the field of vision. The light beam (laser pulses) (122) that are reflected from the object travel towards the sensor element (130) and are sensed. The spherical array elements on the rotator unit (disk) (104) that is being rotated by the rotator unit (apparatus) (140), namely the first row of (first ring) spherical array elements (100), second row (ring) elements (101) and third row (ring) elements (102) start to rotate together with the rotator unit (disk) (104). When the rotation begins, each of the spherical array elements illuminates a different point in space (predetermined or not predetermined) with the aid of the light source (131). This section has been drawn in detail in FIG. 1. The beams that are reflected back from the object numbered 122, is detected by the sensor element (130) in order to calculate flight time. As it has already been mentioned the spherical array elements on the rotating unit (disk) (104) have been directed to different sections of space. As it has been mentioned in FIG. 1, a plurality of spherical element arrays can be used. Similarly, a plurality of light sources (131) can be used. The entire disk can be filled with these elements in order to reach the desired resolution and scanning speed in order to overcome the bottlenecks of electro-optical elements. Similarly, it can be a plurality of disks. In order to sense the beams reflected from objects or that are emitted from different sources, a plurality of detectors can be used. These detectors can be avalanche photodiodes, (a silicon avalanche photodiode has been used for this design) photocells, single-photon sources, thermal sensors and/or other types of photodiodes. At the same time, camera sensors can also be used (CCD, CMOS).

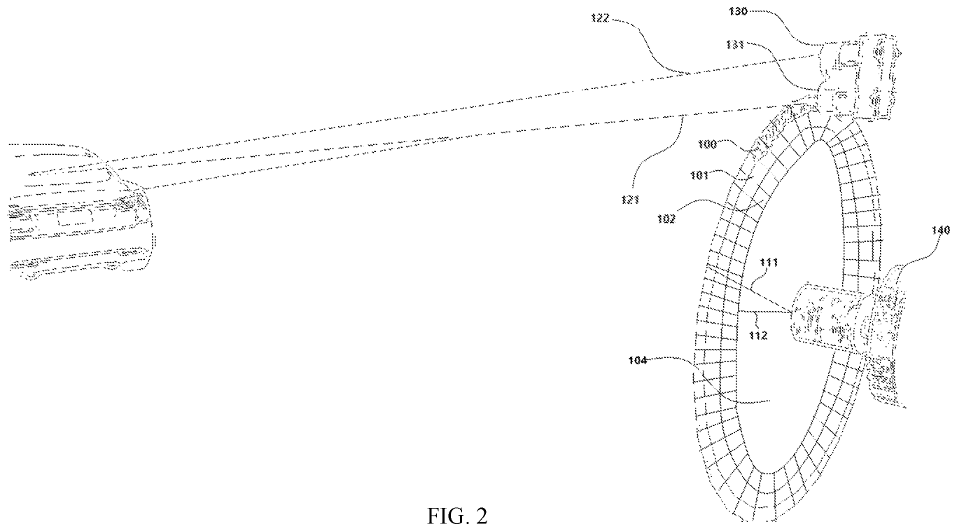

In FIG. 2, the design for permeable optical elements can be viewed. Resolution is reduced as distance increases in LIDAR designs. The system designed with two mirrors enables high-resolution scanning from a long distance.

In the figures, designs for systems comprising a plurality of disks can be viewed. It enables a plurality of disks that have been designed according to requirements and the usage of these disks independently.

An adaptive method and mechanisms for fast LIDAR (light detection and range determination) and positioning applications, according to the information given above, characterized by comprising;
at least one LIDAR ranging apparatus,
at least one mechanical light director formed of elements formed on a disk for LIDAR systems that are based on the calculation of flight times and to the principle of changing the direction of light by means of the directing elements or designs of elements placed on a disk,
at least one rotator unit (140),
at least one light source (131),
at least one optical sensor element (130),
at least one power regulating electronics,
at least one power control electronics,
at least one data converter electronics,
at least one control electronics,
at least one processor unit.

According to another embodiment of the invention, the invention is a 3D scanning system, characterized in that it comprises at least one LIDAR, at least one mechanical light director integrated with at least one disk, at least one light source, at least one optical sensor, at least one optical diffuser which simultaneously separates light beams that are emitted from the at least one light source and which transmits said beams to optical sensors together with the elements on the disk, at least one power control unit, at least one control unit, at least one data converter electronics and at least a processor electronics.

An adaptive method for fast LIDAR (light detection and range determination) and positioning applications, according to the information given above, wherein the method is characterized by comprising;
Determination of the field of view of the system,
Determination of the resolution values within the field of vision,
Determination of the radius of the disk and number of rings required for the desired resolution value,
Determination of the direction of the elements that have been aligned on the disk as a spherical array, to be either permeable or reflective according to system design,
Determination of the rotation speed of the disk according to the desired refreshing speed,
Rotation of the disk,
Illuminating the elements on the disk with a light source,
Sensing the light beams reflected from the object at the scan area,
Determination of distance by calculating the flight time of light,
Drawing out the 3D map of the target region.

A 3D scanning system mechanism in accordance with the information disclosed above, characterized in that it comprises at least a LIDAR, at least one mechanical light directing unit integrated with at least one disk, at least one light source, at least one optical sensor, at least one optical diffuser which simultaneously separates light beams that are emitted from the at least one light source and which transmits said beams to optical sensors together with the elements on the disk, at least one power control unit, at least one control unit, at least one ranging apparatus, at least a mirror required for spatial scanning, at least a data converter electronics and at least a processor electronics.

What is claimed is:

1. An adaptive mechanism for a fast light detection and range determination (LIDAR) and positioning applications, comprising:
at least one LIDAR ranging apparatus,
at least one mechanical light director formed of elements formed on a disk for LIDAR systems based on a calculation of flight times and to a principle of changing a direction of a light by directing elements or designs of the elements placed on the disk,
at least one rotator unit,
at least one light source,
at least one optical sensor element,
at least one power regulating electronics,
at least one control electronics,
at least one data converter electronics, and
at least one processor unit.

2. An adaptive method fora fast light detection and range determination (LIDAR) and positioning applications, comprising:
determination of a field of view of a system,
determination of resolution values within a field of vision,
determination of a radius of a disk and a number of rings required for a desired resolution value,
determination of a direction of elements aligned on the disk as a spherical array, to be either permeable or reflective according to a system design,
determination of a rotation speed of the disk according to a desired refreshing speed,
rotation of the disk,
illuminating the elements on the disk with a light source,
sensing light beams reflected from an object at a scan area,
determination of a distance by calculating a flight time of a light, and
drawing out a 3D map of a target region.

3. The adaptive mechanism according to claim 1, wherein in the at least one mechanical light director, the elements on the disk are formed of mirrors.

4. The adaptive mechanism according to claim 3, wherein the mirrors are selected from micromirrors, concave, convex and dual optical mirrors.

5. The adaptive mechanism according to claim 1, wherein in the at least one mechanical light director, the elements on the disk are formed of prisms.

6. The adaptive mechanism according to claim 5, wherein the prisms are selected from micro prisms, concave, convex, and dual optic prism structures.

7. The adaptive mechanism according to claim 1, wherein in the at least one mechanical light director, the elements on the disk are phase masks.

8. The adaptive mechanism according to claim 7, wherein each of the phase masks has a continuous structure or a discontinuous structure.

9. The adaptive mechanism according to claim 1, wherein in the at least one mechanical light director, the elements on the disk are light sources.

10. The adaptive mechanism according to claim 1, wherein the at least one mechanical light director comprises the disk formed of at least one element of the elements.

11. The adaptive mechanism according to claim 1, wherein the elements on the at least one mechanical light director form at least one serial structure.

12. The adaptive mechanism according to claim 1, wherein the disk of the at least one mechanical light director has a monotype element on the at least one mechanical light director.

13. The adaptive mechanism according to claim 1, wherein the at least one optical sensor element is an avalanche photodiode.

14. The adaptive mechanism according to claim 1, wherein the at least one optical sensor element comprises positive semi-conductive, negative diodes.

15. The adaptive mechanism according to claim 1, wherein the at least one optical sensor element is formed of at least a detector.

16. The adaptive mechanism according to claim 15, wherein the at least one optical sensor element is formed of avalanche photodiodes.

17. The adaptive mechanism according to claim 16, wherein the at least one optical sensor element is electrically or optically connected to reading circuits.

18. The adaptive mechanism according to claim 15, wherein the at least one optical sensor element is formed as a focal planed array of photodiodes, wherein the photodiodes are formed of a plurality of detectors.

19. The adaptive mechanism according to claim 1, wherein the at least one light source is at least a laser, a led, a fluorescence, or light sources based on an electricity discharge or a glow lamp.

20. The adaptive mechanism according to claim 19, wherein the laser is a single laser and/or a multiple pulsating laser.

21. The adaptive mechanism according to claim 19, wherein the at least one light source is an optical diffuser, wherein the optical diffuser is a cube beam splitter, a prism beam splitter, a pellicle beam splitter, or a partially metalized mirror used to simultaneously split a first laser beam and transmit the first laser beam to the elements on the disk of the LIDAR systems, and at the partially metalized mirror, a second laser beam is transmitted to the at least one optical sensor of the LIDAR systems, wherein the at least one optical sensor of the LIDAR systems further divides a visible light intensity or an infrared light intensity into sections.

22. The adaptive mechanism according to claim 21, wherein the optical diffuser is made of an amorphous silicon crystal, nitrite or a material having a crystal structure.

23. The adaptive mechanism according to claim 19, wherein the light sources are hybrid or monolithically integrated with optical boosters, optical sensors, detector electronics, the at least one power regulating electronics, the at least one control electronics, the at least one data converter electronics and processors together with one or more light sources, drivers and controller circuits.

24. The adaptive mechanism according to claim 23, wherein the light sources are integrated to a plurality of modules.

25. The adaptive mechanism according to claim 1, wherein the LIDAR systems are directly or indirectly connected to one or more global positioning system sensors, global positioning system satellite sensors, inertial measurement units, wheel encoders, visible video cameras, infrared video cameras, radars, ultrasonic sensors, embedded processors, ethernet controllers, cellular modems, wireless controllers, data recording devices, human-machine interfaces, power supplies, coating, cabling and retainer devices.

26. The adaptive mechanism according to claim 25, wherein in the at least one LIDAR ranging apparatus, the LIDAR and a video camera are integrated onto a same printed circuit.

27. The adaptive mechanism according to claim 1, wherein the at least one rotator unit is an electric motor or a mechanical motor.

28. The adaptive mechanism according to claim 1, wherein the at least one optical sensor element is one or a plurality of phototransistors, thermal sensors or a single-photon detector.

29. A flight time calculation and 3D scanning mechanism, comprising:
at least a LIDAR,
at least one mechanical light director integrated with at least one disk,
at least one light source,
at least one optical sensor,
at least one optical diffuser, wherein the at least one optical diffuser simultaneously separates light beams emitted from the at least one light source and the at least one optical diffuser transmits the light beams to the at least one optical sensor together with elements on the at least one disk,
at least one power control unit,
at least one control unit,
at least one ranging apparatus,
at least a mirror required for a spatial scanning,
at least a data converter electronics, and
at least a processor electronics.

30. The flight time calculation and 3D scanning mechanism according to claim 29, wherein the at least one optical sensor comprises, at least a photodetector.

31. The flight time calculation and 3D scanning mechanism according to claim 30, wherein a plurality of photodetectors are avalanche photodiodes.

32. The flight time calculation and 3D scanning mechanism according to claim 30, wherein the photodetector is connectable to an electrical reading circuit or a photonic reading circuit.

33. The flight time calculation and 3D scanning mechanism according to claim 30, wherein the at least one optical sensor comprising a plurality of photodetectors is in a form of a focal plane array.

34. The flight time calculation and 3D scanning mechanism according to claim 29, the at least one optical sensor is arc integrated on a same printed circuit with the LIDAR.

35. The flight time calculation and 3D scanning mechanism according to claim 34, wherein additionally a light source and a processor is integrated on to the same print circuit.

36. The flight time calculation and 3D scanning mechanism according to claim 29, wherein the mirror and other optical elements required for the spatial scanning are for predetermined angles and in the predetermined angles, the mirror and the other optical elements are placed on a rotating disk.
